(19) United States
(12) Patent Application Publication
(10) Pub. No.: US 2005/0012063 A1
(43) Pub. Date: Jan. 20, 2005

(54) Flexible metal sealing lip

(75) Inventors: Grant R. Thompson, Tulsa, OK (US); Aaron T. Jackson, Tulsa, OK (US); Clifford H. Beall, Broken Arrow, OK (US); Darren E. Bane, Broken Arrow, OK (US); Jeffrey E. Davis, Broken Arrow, OK (US)

Correspondence Address: Gerald W. Spinks, P.O. Box 2467, Bremerton, WA, 98310, US

(73) Assignee: Baker Hughes Incorporated, Houston, TX (US)

(21) Appl. No.: 10/621,161

(22) Filed: Jul. 16, 2003

(51) Int. Cl. F16K 31/44

(52) U.S. Cl. 251/214

(57) ABSTRACT

A low pressure backseat sealing apparatus having a flexible sealing lip which contacts the backseat prior to contact between a stem shoulder and the backseat, with the stem shoulder positioned above the flexible lip, thereby limiting stem movement while allowing internal valve pressure to achieve a seal between the flexible lip and the bonnet.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention is in the field of gate valves.

2. Background Art

Certain valves are required to exhibit a specific ability to seal against leakage around the stem when the valve is in a given position. For example, API specification 6A requires all gate valves to be provided with a back seat, or other means of repacking the stuffing box while the valve is in service and at the maximum pressure for which the valve is rated. This specification also specifies a test wherein the “gas back seat” is tested at 5% to 10% of the working pressure of the valve with nitrogen, with no leakage being allowed.

Typically, the stem and the backseat of a valve have abutting or mating shoulders with matching angles. When the low pressure gas backseat capability is required, during assembly of a valve, the angles on these shoulders are carefully measured and matched, to ensure the greatest probability of passing the low pressure backseat test. This measurement and matching of angles is based largely on the experience of the assembly personnel. When a valve fails the low pressure gas backseat test, it is typically disassembled, and the mating surfaces of the stem and backseat are reworked. The valve is then reassembled and retested. It is sometimes necessary to repeat this process several times, and even repeated reworking sometimes fails.

One object of the present invention is to enhance the ability of the stem to seal reliably within the bonnet, while being sufficiently robust to withstand repeated tests of the gas back seat.

### BRIEF SUMMARY OF THE INVENTION

The present invention solves the backseat testing problem by allowing a portion of the stem structure, such as an annular lip, to flex under the low pressure conditions found in the test, while providing additional support for this flexing structure, preventing overstressing of the flexing structure under full working pressure conditions. The flexing annular lip on the stem forms a metal-to-metal seal against the backseat on the housing. The shape and thickness of the annular lip are designed to allow the lip to flex under the low pressure conditions used in the test and form an effective seal, as the stem is urged against the bonnet by the pressure within the valve body. An annular shoulder is also provided on the valve stem, between the annular lip and the housing. The annular shoulder on the stem is positioned to contact the housing only after the annular lip flexes a sufficient amount to create an effective seal. At pressures higher than the test pressure, the annular shoulder prevents the stem from moving farther toward the housing, thereby preventing overflexing of the annular lip. Positioning of the annular shoulder between the annular lip and the housing allows the internal pressure within the valve to continue to seal the annular lip against the backseat, even after the annular shoulder contacts the housing. The backseat can have a single angled surface, with both the annular lip and the annular shoulder contacting the single surface, or it can have two angled surfaces, with the annular lip contacting one angled surface and the annular shoulder contacting the other angled surface.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a longitudinal section view of one embodiment of the apparatus of the present invention;

FIG. 2 is a partial section view of one embodiment of the backseat sealing arrangement shown in FIG. 1, showing initial contact between the flexible lip and the housing; and

FIG. 3 is a partial section view of the backseat sealing arrangement shown in FIG. 2, showing flexing of the lip.

### DETAILED DESCRIPTION OF THE INVENTION

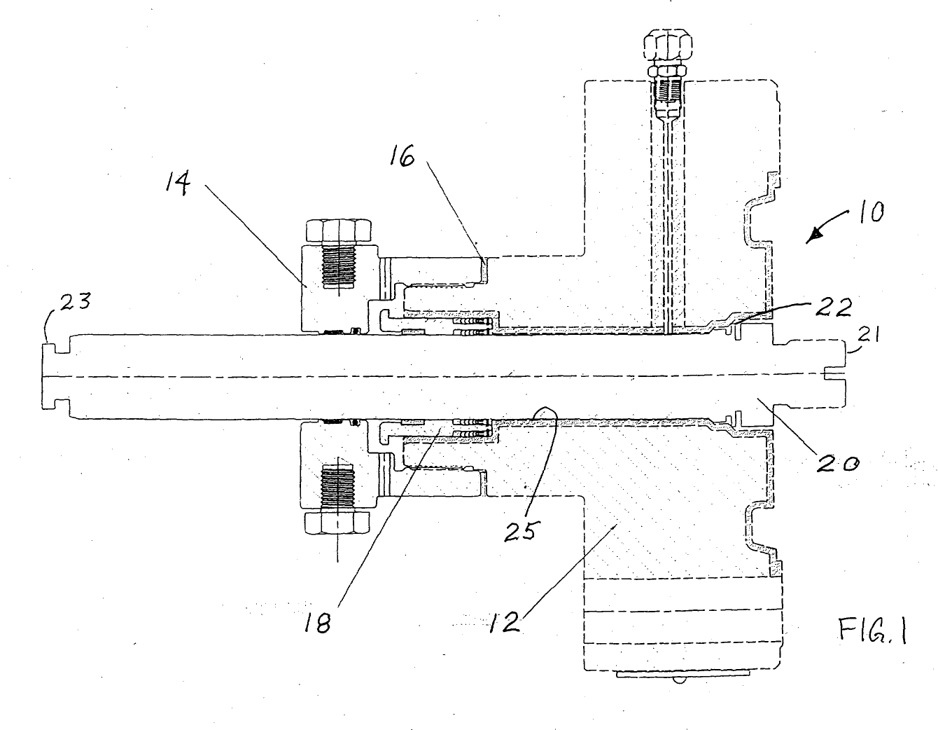

As shown in FIG. 1, one embodiment of the apparatus of the present invention includes a bonnet assembly 10, attached to the top of a gate valve (not shown), consisting of a housing such as a bonnet 12, a bonnet ring 14, spacers 16, a stem seal 18, and a stem 20. The lower end 21 of the stem 20 is attached to the gate (not shown) of the gate valve. The upper end 23 of the stem 20 is machined to interface with an actuator (not shown). Such terms as “lower”, “inward”, and “downward” are used herein to mean toward the inside of the valve body, and such terms as “upper”, “outward”, and “upward” are used to mean toward the outside of the valve body. It should be understood that these terms are only used to indicate position or movement relative to the valve body and bonnet, since the valve could be installed in any orientation relative to its surroundings. The stem 20 is movable within a bore 25 through the bonnet 12. A backseat sealing arrangement 22 is provided on the exterior of the stem 20 and the interior of the bonnet 12.

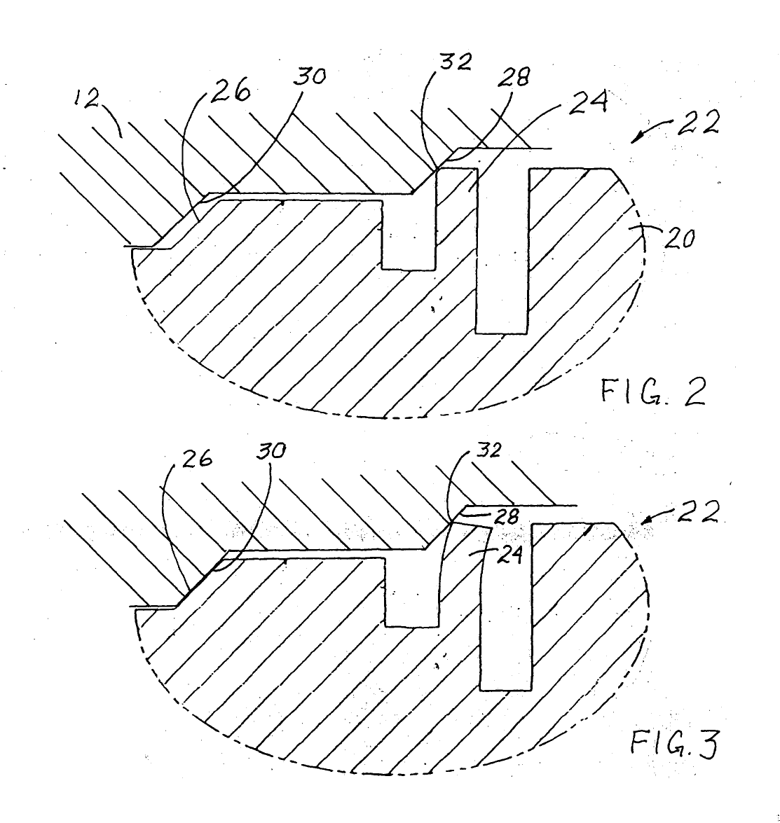

FIGS. 2 and 3 better illustrate the details of one embodiment of the backseat sealing arrangement 22. A radially extending annular lip 24 is provided on the external surface of the stem 20. The annular lip 24 illustrated is a substantially flat annular lip oriented transverse to the longitudinal axis of the stem 20. Another increase in the diameter of the stem 20, such as an external shoulder 26, is provided as a limit on the upward travel of the stem 20 relative to the bonnet 12. The shoulder 26 illustrated has a convex frusto-conical shape. A backseat surface is illustrated as two concave frusto-conical shapes 28,30 on the interior of the valve housing, such as on the interior of the bonnet 12. The backseat surfaces 28,30 provide seating surfaces for the annular lip 24 and the shoulder 26, respectively. The conical angle of the shoulder 26 can be matched to the conical angle of its respective backseat surface 30. An outer annular edge 32 of the annular lip 24 contacts its respective backseat surface 28, substantially along a circle. The backseat surfaces 28,30, the shoulder 26, and the lip 24 are dimensioned and positioned so that, as the stem 20 rises through the bonnet bore 25, the annular lip 24 contacts its respective backseat surface 28 before the shoulder 26 contacts its respective backseat surface 30. This relationship is shown in FIG. 2. The shoulder 26 is positioned above the annular lip 24, or between the annular lip 24 and the housing or bonnet 12.

The backseat surface illustrated has two separate frusto-conical surfaces 28,30, but it can be seen that the backseat surface could also comprise a single frusto-conical surface, if combined with a lip and a shoulder having appropriate sizes and positions to ensure that the lip contacts the backseat surface before the shoulder contacts the backseat surface. That is, with a single frusto-conical backseat surface, the annular lip would simply have a sufficiently larger diameter than shown, to cause the lip to contact the backseat surface before the shoulder contacts the backseat surface.

After the edge 32 of the annular lip 24 contacts the backseat surface 28, internal valve pressure or other influences can cause additional upward movement of the stem 20 relative to the bonnet 12, causing the lip 24 to deflect. The shoulder 26 has a diameter sufficient to limit passage of the stem 20 through the bonnet bore 25, thereby providing an up stop to limit the travel of the stem 20 and the gate (not shown), preventing overstroking or damage to the gate. Specifically, the stem movement is stopped by abutment of the shoulder 26 against the backseat surface 30, as shown in FIG. 3. The up stop is designed with geometry and attention to materials such that operation of the gate valve (including violent movement such as may be experienced during fail-safe operation) will cause no damage to the bonnet 12 or the stem 20. Even thought the shoulder 26 mates with the backseat surface 30, it does not prevent internal pressure in the valve body from acting on the flexible lip 24, because the shoulder 26 is above the lip 24. This allows the lip 24 to continue providing a secure seal against the backseat surface 28, even when the stem 20 is firmly seated against the backseat surface 30.

As the stem 20 strokes a valve, such as in moving a reverse-acting gate valve to the closed position, the flexible annular lip 24 engages the housing or bonnet 12 to act as a low pressure metal to metal seal. Increased pressure inside the valve body forces the stem 20 upward, deflecting the lip 24, until such time as the support shoulder 26 contacts the bonnet 12. At this point, any additional upward force acting on the stem will be translated into a bearing force against the bonnet seat 30 through the support shoulder 26, preventing additional deflection of the flexible sealing lip 24. Controlled deflection of the flexible lip 24 prevents overstressing the lip 24. By sealing on the edge 32 of the lip 24, the design is made more resistant to failure by contamination, as debris is less likely to be trapped between the surface 28 and the edge 32 than between two matching surfaces. A relatively large seat angle is also provided on the backseat surfaces 28,30 and on the shoulder 26, thereby helping to prevent wedging of the stem 20 in the seat 30. Further, as mentioned above, by virtue of the positioning of the up-stop shoulder 26 above the sealing lip 24, between the housing bonnet 12 and the flexible lip 24, unintentional sealing at the up-stop shoulder 26 does not interfere with pressure acting to assist the flex lip 25 in sealing.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

1. A sealing apparatus, comprising:
a housing having a bore formed therethrough;
a cylindrical member extending through said bore in said housing;
an external annular sealing lip formed on said cylindrical member, said lip being adapted to contact said housing and flex in a sealing relationship when said cylindrical member is urged toward said housing; and
an external annular shoulder formed on said cylindrical member between said sealing lip and said housing, said shoulder being adapted to abut said housing only after said flexing of said sealing lip and arrest axial movement of said cylindrical member relative to said housing.

2. The apparatus recited in claim 1, further comprising:
a frusto-conical surface on said housing; and
an annular edge formed on said sealing lip, said sealing lip annular edge being positioned to contact said frusto-conical surface of said housing in said sealing relationship, prior to said abutment of said shoulder against said housing.

3. The apparatus recited in claim 1, further comprising:
a frusto-conical surface on said housing; and
a frusto-conical surface formed on said annular shoulder, said frusto-conical surface of said shoulder being positioned to abut said frusto-conical surface of said housing, after said sealing lip contacts said housing.

4. The apparatus recited in claim 1, further comprising:
first and second frusto-conical surfaces on said housing;
an annular edge formed on said sealing lip, said sealing lip annular edge being positioned to contact said first frusto-conical surface of said housing in said sealing relationship; and
a third frusto-conical surface formed on said annular shoulder, said frusto-conical surface of said shoulder being positioned to abut said second frusto-conical surface of said housing, after said sealing lip contacts said first frusto-conical surface of said housing.

5. The apparatus recited in claim 1, wherein said lip is adapted to contact said housing as said cylindrical member advances through said bore.

6. An apparatus for sealing against valve stem leakage, comprising:
a valve bonnet having a stem bore formed therethrough;
a valve stem extending through said stem bore of said valve bonnet;
an annular backseat formed on an inside surface of said bonnet, surrounding said stem bore;
an external annular sealing lip formed on said stem, within said valve bonnet, said lip being adapted to flex and seal against said backseat when said stem is urged toward said bonnet; and
an external annular shoulder formed on said stem between said sealing lip and said backseat, said shoulder being adapted to abut said backseat only after said flexing of said sealing lip and arrest axial movement of said stem.

7. The apparatus recited in claim 6, further comprising:
a frusto-conical internal surface on said annular backseat; and
an annular edge formed on said sealing lip, said sealing lip annular edge being positioned to contact said frusto-conical internal surface of said backseat in a sealing relationship, prior to said abutment of said shoulder against said backseat.

8. The apparatus recited in claim 6, further comprising:
a frusto-conical internal surface on said annular backseat; and
a frusto-conical external surface on said annular shoulder, said frusto-conical surface of said shoulder being positioned to abut said frusto-conical internal surface of said backseat, after said sealing lip contacts said backseat.

9. The apparatus recited in claim 6, further comprising:
first and second frusto-conical surfaces on said annular backseat;
an annular edge formed on said sealing lip, said sealing lip annular edge being adapted to contact said first frusto-conical backseat surface; and
a third frusto-conical surface on said annular shoulder, said frusto-conical surface of said shoulder being positioned to abut said second frusto-conical backseat surface, after said sealing lip contacts said first frusto-conical backseat surface.

10. The apparatus recited in claim 6, wherein said lip is adapted to contact said backseat as said stem advances outwardly through said stem bore.

11. An apparatus for sealing against valve stem leakage, comprising:
a valve bonnet having a stem bore formed therethrough;
a valve stem extending through said stem bore of said valve bonnet;
an annular backseat formed on an inside surface of said bonnet, surrounding said stem bore, said backseat comprising at least one frusto-conical surface;
an external annular sealing lip formed on said stem, an annular edge of said lip being adapted to contact said at least one frusto-conical backseat surface in a sealing relationship, said lip being adapted to flex when said stem is urged toward said bonnet; and
an external annular shoulder formed on said stem between said sealing lip and said backseat, said shoulder being adapted to abut said backseat only after said flexing of said sealing lip and arrest axial movement of said stem.

12. The apparatus recited in claim 11, further comprising a frusto-conical external surface on said annular shoulder positioned to abut said at least one frusto-conical backseat surface, after said sealing lip contacts said backseat in said sealing relationship.

13. The apparatus recited in claim 12, wherein:
said annular backseat comprises first and second said frusto-conical surfaces;
said annular edge of said lip is adapted to contact said first frusto-conical backseat surface; and
said frusto-conical external surface of said annular shoulder is positioned to abut said second frusto-conical backseat surface, after said sealing lip contacts said first frusto-conical backseat surface.

14. The apparatus recited in claim 11, wherein said lip is adapted to contact said backseat as said stem advances outwardly through said stem bore.

15. A method of sealing between a cylindrical member and a housing, comprising:
providing a cylindrical member extending through a bore in a housing;
providing an external annular sealing lip and an external annular shoulder on said cylindrical member, said shoulder being positioned between said sealing lip and said housing;
urging said cylindrical member toward said housing to flex said lip and seal said lip against said housing; and
then, abutting said shoulder against said housing, thereby arresting axial movement of said cylindrical member relative to said housing.

16. The method recited in claim 15, further comprising:
providing a concave frusto-conical surface on said housing and an annular edge on said sealing lip; and
sealing said sealing lip annular edge against said concave frusto-conical surface of said housing, before said abutting of said shoulder against said housing.

17. The method recited in claim 15, further comprising:
providing a concave frusto-conical surface on said housing and a convex frusto-conical surface on said annular shoulder; and
abutting said convex frusto-conical surface of said shoulder against said concave frusto-conical surface of said housing, after said sealing of said lip against said housing.

18. The method recited in claim 15, further comprising:
providing first and second concave frusto-conical surfaces on said housing, an annular edge on said sealing lip, and a convex frusto-conical surface on said annular shoulder;
sealing said sealing lip annular edge against said first concave frusto-conical surface of said housing; and
then, abutting said convex frusto-conical surface of said shoulder against said second concave frusto-conical surface of said housing.

19. The method recited in claim 15, further comprising advancing said cylindrical member through said bore to cause said sealing lip to contact said housing.
